(19) United States
(12) Patent Application Publication
(10) Pub. No.: US 2025/0005375 A1
(43) Pub. Date: Jan. 2, 2025

(54) FEDERATED LEARNING WITH MODEL DIVERSITY

(71) Applicant: Robert Bosch GmbH, Stuttgart (DE)

(72) Inventors: Zhenzhen Li, Gibsonia, PA (US); FILIPE J. CABRITA CONDESSA, Pittsburgh, PA (US); Madan Ravi Ganesh, Pittsburgh, PA (US); Wan-Yi Lin, Wexford, PA (US); Chen Qiu, Pittsburgh, PA (US)

(21) Appl. No.: 18/216,982

(22) Filed: Jun. 30, 2023

(51) Int. Cl. G06N 3/098

(52) U.S. Cl. CPC G06N 3/098

(57) ABSTRACT

Methods and systems for federated learning in a machine learning environment are disclosed. At least portions of a plurality of server-maintained machine learning models are sent from a server to a plurality of clients, yielding a plurality of local machine learning models. At each client, the plurality of local machine learning models are trained with locally-stored data that is stored locally at that respective client. A respective loss for each of the plurality of local machine learning models is determined, and respective weights for each of the plurality of local machine learning models are updated. The respective updated weights from each client are transferred to the server without transferring the locally-stored data of the clients. At the server, the plurality of server-maintained machine learning models are trained with the updated weights sent from each of the clients.

### TECHNICAL FIELD

The present disclosure relates to methods and systems of federated learning with diversity in machine learning models.

### BACKGROUND

Federated learning (also known as collaborative learning) is a machine learning technique that trains a machine learning algorithm via multiple independent sessions, each using its own dataset. Federated learning aims at training a global machine learning algorithm, for instance deep neural networks, based on multiple local datasets contained in local nodes (also referred to as clients) without explicitly exchanging data samples. The learning task is solved by a federation of participating devices coordinated by a central server. Each participating device (client) has a local training dataset which is not uploaded to the server. Instead, each client computes an update to the current global model maintained by the server. The clients communicate this update, but not the training dataset, to the server for updating the global model. The resulting shared model can be trained by learning from the training of the clients, thus allowing users to reap the benefits of shared models trained from the data of the clients without having to transfer or centrally store the data from the clients. This has particular usefulness in situations where the exchange of sensitive or personal data is precluded (e.g., medical information, Internet of Things devices, personal devices such as smart phones).

### SUMMARY

According to one embodiment, a method of training neural networks with federated learning is provided. At least portions of a plurality of server-maintained machine learning models are sent from a server to a plurality of clients, yielding a plurality of local machine learning models. At each client, the plurality of local machine learning models are trained with locally-stored data that is stored locally at that respective client. A respective loss for each of the plurality of local machine learning models is determined, and respective weights for each of the plurality of local machine learning models are updated. The respective updated weights from each client are transferred to the server without transferring the locally-stored data of the clients. At the server, the plurality of server-maintained machine learning models are trained with the updated weights sent from each of the clients. In an embodiment, a non-transitory computer readable storage medium tangibly embodying a computer readable program code having computer readable instructions that, when executed, cause a computing system to train neural networks with federated learning by performing the same.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3A shows an example diagram or layout of a federated learning system, according to an embodiment; FIG. 3B shows a flow chart of a method of training neural networks via federated learning.

FIG. 4 shows a schematic of a deep neural network with nodes in an input layer, multiple hidden layers, and an output layer, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The present disclosure relates to federated learning. References herein to a “server” of the federated learning system refer to the centralized server(s) that communicate to the clients to exchange data therewith. For example, one or more servers in the cloud or remote from end users can constitute a server. References herein to a “client” of the federated learning system refer to local nodes or devices corresponding to a particular end user. For example, a smart phone, Internet of Things device, or the like would constitute a client. Each of the server and the client can utilize a respective computer system for machine learning training, such as those described herein.

Federated learning (also known as collaborative learning) is a machine learning technique that trains a machine learning algorithm via multiple independent sessions, each using its own dataset. Federated learning aims at training a global machine learning algorithm (e.g., deep neural networks) based on multiple local datasets contained in local nodes (also referred to as clients) without explicitly exchanging data samples. The learning task is solved by a federation of participating devices coordinated by a central server. Each participating device (client) has a local training dataset which is not uploaded to the server. Instead, each client computes an update to the current global model maintained by the server. The clients communicate this update, but not the training dataset, to the server for updating the global model. The resulting shared model can be trained by learning from the training of the clients, thus allowing users to reap the benefits of shared models trained from the data of the clients without having to transfer or centrally store the data from the clients.

Federated learning has particular usefulness in situations where the exchange of sensitive or personal data is precluded (e.g., medical information, Internet of Things devices, personal devices such as smart phones). Take smart phones as a simple, everyday example. When people type an email or text message, they might have an auto-correct or auto-fill feature that will automatically correct a person's spelling mistake or suggest corrections or additions to the text. This sort of system typically relies upon a machine learning model that is trained based on previous word usage of the user, and might differ from user to user. Because of the sensitive nature of the information used, the raw data of the words types by the user is not sent to a central server to train the model. Rather, the user's smart phone can receive a base model from the server, and can train that model locally to perform auto-correct in a manner that is tailored to that particular user's history of word usage. Information about how the model was trained locally can be sent to the server without requiring the raw data (e.g. the user's words and/or the corrections) to be sent to the server.

Federated learning is a technique that enables data to remain locally stored on clients' devices while the server functions as orchestrator for the learning process, aggregate learned information and synchronize with clients (e.g. users, AI tasks, . . . ). However, the system can experience reduced efficiency and robustness due to issues like data heterogeneity, distribution shifts, and communication can be unreliable and even in cases with hardware failures. Additionally, various federated learning architectures have been proposed, such as single global models and peer-to-peer with individual models, some of which include personalized versions.

FedAvg is a type of federated learning technique in which a distributed machine learning algorithm allows clients to collaboratively train a global server model while keeping their data locally stored and private. It works by sending the initial model from the server to clients, aggregating the clients' updates into a global model, and repeating this process until convergence is achieved. FedAvg enables updating the global model by aggregating the knowledge and insights of multiple clients. However, usually the server only has one model stored and can suffer from accuracy drop and non-robustness due to distribution shift as well as data heterogeneity. In addition, in many of the applications clients have different capabilities in memory, computational resources and other hardware properties. Moreover, having one single model may cause resources waste for some clients, and also computational overload for other clients.

Given the aforementioned challenges and the variety of federated learning architectures and frameworks, the present disclosure aims to address these issues by proposing a novel federated learning framework. Although others suggest model interpolation methods for federated learning systems using either a global model or other clients' models, and yet others posit that diverse models can enhance robustness, the present disclosure's approach differs in several aspects. For example, the present disclosure presents a framework in which servers, acting as a federation, store learnable and diverse models, while clients' models are formed by combining these diverse models. Simultaneously, clients contribute to training the models within the federation. To ensure model diversity during training, embodiments of the present disclosure provides a framework that incorporates interpolation methods to accommodate distribution shifts and even connection failures from clients. Moreover, the present disclosure provides backup solutions for cases with unsuccessful communication in federated training system. This provides solutions for non-robustness existing in hardware properties.

Whereas prior works present model interpolation ideas (global model at the server, or clients' model) for a federated learning system, the present disclosure focuses on multi-resolution model combination with novel orthogonal constraints. In prior works, model interpolation was only used to get better performances for federated training but is not used to provide backup solutions when communication failures happen. The present disclosure provides backup solutions for such failed connection cases.

To address the problems of representation insufficiency as well as computational efficiency, this disclosure proposes embodiments including the following method. A pool of multiple models is stored on a server or repository from which each client pulls or retrieves for each learning round. Clients can select and pull from a list of models based on their resources limit and train the models locally on their own data. After local training, clients can send back information for the server or repository to aggregate and update the multiple models. Adding orthogonal regularization for neural network training can boost model performance as well as robustness and diversity. Therefore, this disclosure provides a novel client-side loss functions to help the optimization process driving the learning task as well as a server-side loss function to ensure and achieve the diversity property. In this way, the training of multiple models having diverse (semi-orthogonal) properties in the federation is performed.

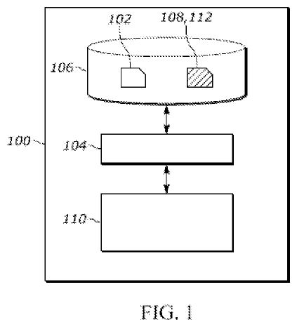

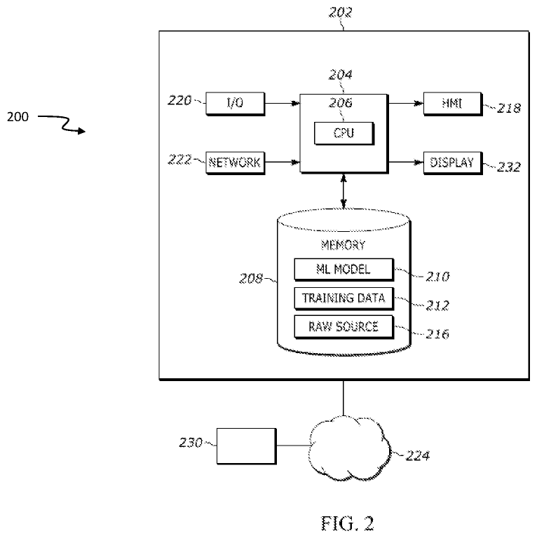

The federated learning system can utilize machine learning training and processes shown in FIGS. 1-2. FIG. 1 shows a system 100 for training a neural network, e.g. a deep neural network. The neural network being trained may reside on the server or the client. In other words, both the server and the client may utilize the teachings of FIG. 1. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The structure of the system 100 is one example of a system that may be utilized to train the models utilized by the federated learning system described herein. Additional structure for operating and training these machine-learning models is shown in FIG. 2.

FIG. 2 depicts a federated learning system 200 configured to execute and train the machine-learning models described herein, for example the neural networks or deep neural networks. The system 200 can be implemented to perform the federated learning processes described herein. The system 200 may include at least one computing system 202. The computing system 202 may be part of or executed by a client device, such as a smart phone, Internet of Things device, medical device, or other device such as those described herein with reference to FIGS. 6-11 described below. By way of example and not by way of limitation, computing system 202 may be an embedded computer system, a system-on-chip (SoC), a single-board computer system (SBC) (such as, for example, a computer-on-module (COM) or system-on-module (SOM)), a laptop computer, a personal device such as a smart phone or tablet, a mesh of personal devices, or a combination of these. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system-on-chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud, enabling the device executing the computing system 202 (e.g., client device) to communicate with the server 230.

The external network 224 may be referred to as the world-wide web or the Internet. The external network 224 may establish a standard communication protocol between computing devices. The external network 224 may allow information and data to be easily exchanged between computing devices and networks.

One or more servers 230 may be in communication with the external network 224. Each server may include a computing system, such as computing system 202, so that the server 230 is configured to perform machine learning and train neural networks. Of course, in keeping with the spirit of this disclosure, certain personal or sensitive raw source data 216 that originate from a particular client device may not transfer to the server 230, and thus the raw source data at the server may be non-existent or may be completely independent of the raw source data on a computing system 202 of a client device. During operation of the federated learning system, as will be described below, the computing system 202 associated with a client device may exchange parts of the training data 212 but not the raw source data 216 or any personal data so as to preserve privacy for any sensitive personal data residing on the client device. The server 230 can then access this information via connection to the network 224, and update its stored models on the server-side.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, camera, sensors, etc. Examples of output devices include monitors, screens, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as a keyboard, mouse, touchscreen, voice input devices (e.g., microphone), and other similar devices. The computing system 202 may include a display device 232. The computing system 202 may include hardware and software for outputting graphics and text information to the display device 232. The display device 232 may include an electronic display screen, projector, printer, speaker, or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. In particular, a client device may implement the computing system 202, and the server 230 may also include its own computing system 202. The particular system architecture selected may depend on a variety of factors.

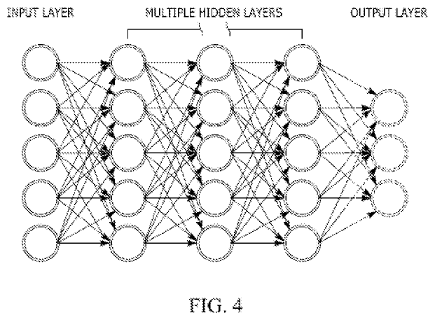

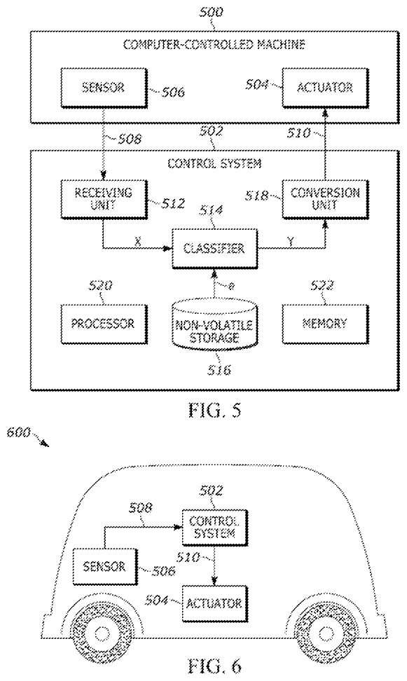

The federated learning system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). The raw source dataset 216 may include sensitive or personal data with heightened security necessities, and therefore the raw source dataset 216 may not transfer from the client device to the server 230. Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The neural network algorithm may be configured to auto-correct text or speech based on the context of the words from the individual.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a person in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., a particular word, in the case where text or spoken words is the input). The raw source data 216 may be derived from a variety of sources. For example, the raw source data 216 may be actual input data collected by a machine-learning system. The raw source data 216 may be machine generated for testing the system. As an example, the raw source data 216 may include raw images or video from a camera, spoken words from a microphone, or typed or written words from a keyboard or touch screen, or the like.

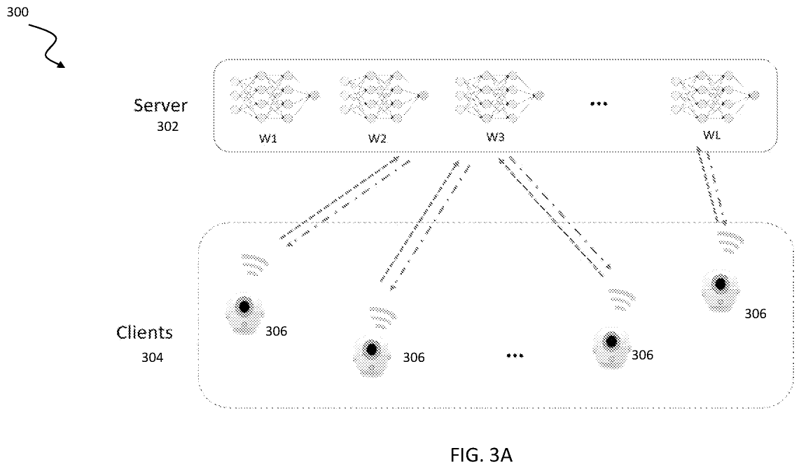

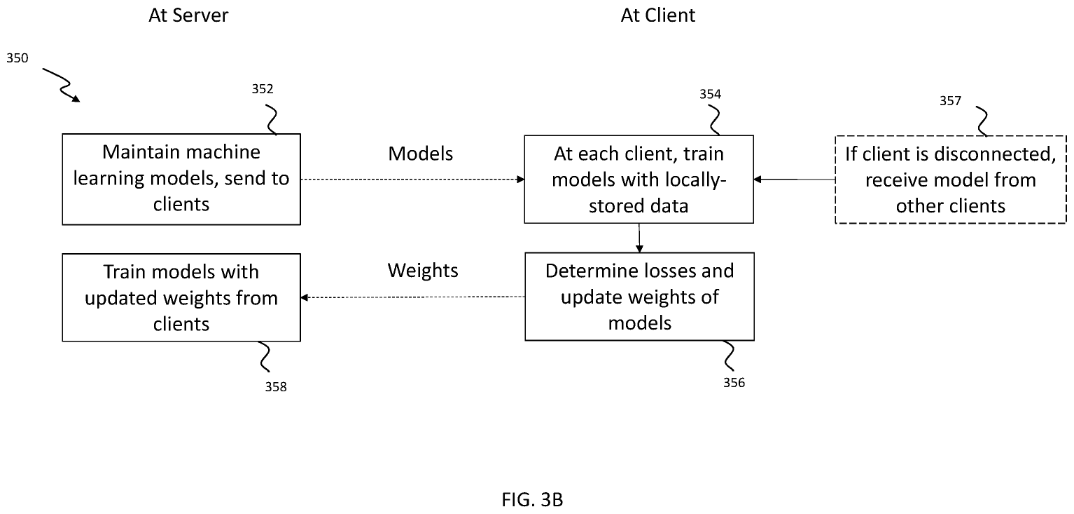

FIG. 3A illustrates an example diagram or layout of a federated learning system 300, according to an embodiment. Here, the federated learning system 300 includes a server 302 and a pool 304 of multiple client devices 306. The server 302 can correspond to server 230, and the client devices 304 can correspond to devices described above (e.g., cameras, smart phones, etc.). Both the server 302 and each of the client devices 306 can execute the machine-learning processes described herein via, for example, a respective computing system 202. The server 302 can be a centralized server that stores a number L of initialized (e.g., randomly) models (e.g., neural network-based), denoted as W₁, W₂, . . . , W_{L}. W_{con} represents concatenated weights of models W₁, W₂, . . . , W_{L}. The server 302 can orchestrate and coordinate federated training, send and receive information from clients, select clients to participate in each round of training, and aggregate information received from clients.

Each of the client devices and server may operate with a set of parameters. In an embodiment, a client pool shown at 304 contains a number N of clients 306 in the federated learning system 300. The clients have categorized levels of hardware resources (computation, memory, etc.). A number of incrementally pulled models by client-i is denoted l, wherein lᵢ∈ [L]. A larger lₗ indicates better hardware properties at hand (e.g., a device with more computational resources, processing power, memory, etc.). Further, Sᵢ={1,2, . . . , lᵢ} can represent the set of model index for client-i, and Zₗ={i: l ∈Sᵢ} where Zₗ is the index for clients who pulled model-l. For each client-i, its locally stored data is denoted as (Dᵢ, yᵢ). For each client, its local models are W₁⁽ⁱ⁾, W₂⁽ⁱ⁾, . . . , Wₗ_{ᵢ}⁽ⁱ⁾.

Assuming, for example, a set of selected intermediate layers output latent features (defined by different task, architecture, and data driven criteria), these features can be represented as

$${g}_{{W}_{1}^{( i )}} ( {D}_{i} ) , {g}_{{W}_{2}^{( i )}} ( {D}_{i} ) , … , {g}_{{W}_{{l}_{i}}^{( i )}} ( {D}_{i} ) .$$

Additionally, there may be some other parameters as follows. For client local training, a number of epochs trained in between each communication (to server) round, batch size, learning rate, optimizer type, and so on. With a connected neighbor group denoted as G, clients with failures can be of the index b. Therefore, the neighbors of client-b can be denoted as C_{b}={i, G(i, b)≠0}.

The neural networks trained and executed at either the server 302 or client devices in the client pool 304 can be exemplified by the illustration shown in FIG. 4. FIG. 4 illustrates an embodiment of a model subject to the training by either the server or client. As discussed above, the federated learning system may include machine learning models such as neural network (e.g., and in some cases, while not required, a deep neural network) based models. The model can include an input layer (having a plurality of input nodes) and an output layer (having a plurality of output nodes). In some examples, the model may include a plurality of hidden layers. The nodes of the input layer, output layer, and hidden layers may be coupled to nodes of subsequent or previous layers. And each of the nodes of the output layer may execute an activation function—e.g., a function that contributes to whether the respective nodes should be activated to provide an output of the model. The quantities of nodes shown in the input, hidden, and output layers are merely exemplary and any suitable quantities may be used.

Referring back to FIG. 3A, in the beginning of every round of federated training, the server 302 sends models information to each qualified (e.g. online, in charge, etc.) client device 306, e.g. W₁⁽ⁱ⁾, W₂⁽ⁱ⁾, . . . , Wₗ_{ᵢ}⁽ⁱ⁾ This can be done over a networked communication, such as illustrated and described with reference to FIG. 2. After each client device 306 receives the information from the server 302, each client device 306 begins training on their locally-stored data, (Dᵢ, yᵢ). The loss of each client-i is denoted by Lᵢ:

$${L}_{i} = loss ( {\sum }_{j = 1}^{{l}_{i}} {f}_{{W}_{j}} ( {D}_{i} ) , {y}_{i} ) + {λ}_{i} R ( {g}_{{W}_{1}^{( i )}} ( {D}_{i} ) , {g}_{{W}_{2}^{( i )}} ( {D}_{i} ) , … , {g}_{{W}_{{l}_{i}}^{( i )}} ( {D}_{i} ) ) \qquad ( 1 )$$

where A is an adjustable hyperparameter corresponding to a regularization term controlling the relative weight between learning the task, achieving or ensuring model diversity. As

$${g}_{{W}_{1}^{( i )}} ( {D}_{i} ) , {g}_{{W}_{2}^{( i )}} ( {D}_{i} ) , … , {g}_{{W}_{{l}_{i}}^{( i )}} ( {D}_{i} )$$

represents latent features from selected intermediate layers, the concatenated latent features can be represented as

$${G}_{W}^{i} = [ {g}_{{W}_{1}^{( i )}} ( {D}_{i} ) , {g}_{{W}_{2}^{( i )}} ( {D}_{i} ) , … , {g}_{{W}_{{l}_{i}}^{( i )}} ( {D}_{i} ) ] \qquad ( 2 )$$

A regularization term R can be defined as

$$R ( {g}_{{W}_{1}^{( i )}} ( {D}_{i} ) , {g}_{{W}_{2}^{( i )}} ( {D}_{i} ) , … , {g}_{{W}_{{l}_{i}}^{( i )}} ( {D}_{i} ) ) = dist ( {G}_{W}^{{i}^{T}} {G}_{W}^{i} , I ) \qquad ( 3 )$$

The distance function of equation (3) can be represented as dist(A,B)=∥A−B∥_{F}², or ∥A−B∥_{∞} or σ(A−B), or a weighted average of them, with σ as spectral norm, or angular margin contrastive regularizer, etc. Client-i can solve (either exactly or approximately) the optimization for loss denoted in equation (1) above, and derives updates for W₁⁽ⁱ⁾, W₂⁽ⁱ⁾, . . . , Wₗ_{ᵢ}⁽ⁱ⁾.

The client devices can then send the updated weights to the server for aggregation and update of the models on the server side, without transferring personal, raw source data. In the aggregation phase, the server receives information from the clients and performs aggregation. To aggregate the information and have model diversity, the server can solve the following optimization to get updates for W₁, W₂, . . . , W_{L}:

$${min}_{{W}_{1} , {W}_{2} , … , {W}_{L}} {\sum }_{l = 1}^{L} {‖ \frac{1}{\vert {Z}_{l} \vert} {\sum }_{i ∈ {Z}_{l}} {W}_{l}^{( i )} - {W}_{l} ‖}_{F}^{2} + λ {‖ {W}_{con}^{T} {W}_{con} - I ‖}_{F}^{2} \qquad ( 3 )$$

Here, the first term can be changed to other kinds of reweight and the second term can be generated to other metrics. Note here that W_{con} denotes the concatenated weights of the plurality of server-maintained machine learning models W₁, W₂, . . . , W_{L}. The aggregation process in the server side solve an optimization problem to find updated weights W₁, W₂, . . . , W_{L}, such that each Wₗ is close to the average of weights collected from clients who pull model-l (or, say whose model sets Sᵢ has model-l), and also try to satisfy the diversity constraints ∥W_{con}^{T}W_{con}-∥_{F}²].

This process can repeat or be looped until a stop criteria is achieved, such as convergence, or a certain number of rounds, or a tolerance. Alternatively, this process can repeat or be looped continuously for continuous learning.

In addition to the training process, if any client-b has communication failure to the server, this disconnected client (or the node) can pull the machine learning model from its neighboring clients or nodes and do an interpolation of their models as follows:

$${W}_{+} = W + {\sum }_{\{ i ∈ {C}_{b} \}} {A}_{i} \cdot ( {W}_{i} - W ) \qquad ( 4 )$$

wherein Aᵢ is a linear combination weight for model Wᵢ. In one embodiment,

$${A}_{i} = \frac{{L}_{b} ( W ) - {L}_{b} ( {W}_{i} )}{{‖ W - {W}_{i} ‖}_{2}} ,$$

with neighbors of client-b denoted as C_{b}={i, G(i, b)≠0}.

With this description in mind, FIG. 3B illustrates a flow chart of a method 350 of training neural networks via federated learning. The method has a server-side, wherein functions are performed at one or more of the servers (e.g., server 230), and a client-side, wherein functions are performed at the clients (e.g., client devices 306). At 352, the server maintains a plurality of machine learning models, for example models W₁, W₂, W₃ . . . , W_{L} shown at 302. These models can be global models that can be distributed amongst a variety of client devices.

The models are transferred to the various clients. The models selected for transferring can match the needs or requirements of the clients that they are being transferred to. Then, at each of the clients the models are transferred to, the models are trained with locally-stored data on that respective client. In other words, each client device uses its own locally-stored data (Dᵢ, yᵢ) to train the model(s) that it receives from the server.

During the training, at 356 each client device can determine losses and update weights of the models that it trains at that particular client device. The loss of each client device is shown in equation (1) above, as an example. An adjustable hyperparameter corresponding to a regularization term R controls the relative weight between learning the particular task and achieving model diversity. The regularization is shown in equation (2) above as an example.

If a client becomes disconnected from communication with the server or is otherwise unable to receive the model from the server, then an optional backup step 357 is provided. Here, the disconnected client (e.g., client-b) or the node can pull the model from its neighbors. For example, the client device can connected to nearby client devices and receive the model from those nearby devices. This can occur over wireless communication, such as any of the wireless communication examples described herein. In one embodiment, the disconnected client is first matched with another client that has similar make, model, network settings, or the like which can assure that the proper model can be transferred from the connected device to the disconnected device. In an embodiment, the disconnected device client-b can do an interpolation of the received models from the connected client(s) as per equation (4) above. The neighboring client can be selected to communicate the model with the disconnected client based on the neighboring client being within range of certain wireless communication, such as direct client-to-client communication (e.g., Wi-Fi, Bluetooth, short-range communication, dedicated short range communication (DSRC), etc.), such Once the disconnected device client-b receives the model(s) from the other neighbor devices or nodes, the disconnected device client-b can perform the training of 354 and loss determination and weight updating of 356 based on the locally-stored data in the disconnected device client-b.

The updated weights, as trained with the locally-stored data at the clients, can then be transferred to the server. Again, it should be noted that the locally-stored data is not transferred. At 358, the server trains its plurality of machine learning models with the received information from the clients. In particular, the server can adjust the weights of its models based on the adjust weight information gleaned from the client devices. This can be done in an aggregation, using equation (3) as an example. Losses can also be determined on the server side during the training at the server.

All or part of the steps 352-358 can be repeated in a loop until convergence, for example, or continuously in continuous learning.

The machine-learning models described herein can be used in many different applications. As described above, the raw source data that is locally-stored may be image data, sound data, or the like, and thus various applications in which this data is retrieved or used are shown in FIGS. 6-11 as an example. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, microphone, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may be any of the processors or processor subsystems described above with reference to FIGS. 1-2, and may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, tensor processing unit, graphics processing unit, ASIC, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIGS. 6-11 illustrate embodiments of environments in which the federated learning systems described herein can be implemented. Each of these embodiments show an embodiment of a client device. Data originating from the sensor 506 in these embodiments may be the raw source data that is used to train a machine learning model onboard the device (client), but not transferred to the server for protection of the data. FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, microphone, radar sensors, ultrasonic sensors, LiDAR sensors, and/or position sensors (e.g. GPS). One or more of the one or more specific sensors may be integrated into vehicle 600. Sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects. The raw source data for the federated learning may include the raw images of the vehicle surroundings, however the vehicle's processing of the objects in the surrounding environment might alter weights in the machine learning model used onboard the vehicle; these adjusted weights can then be sent back to the server's models for updating.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

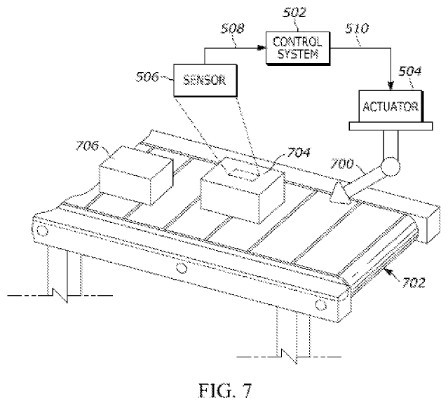

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

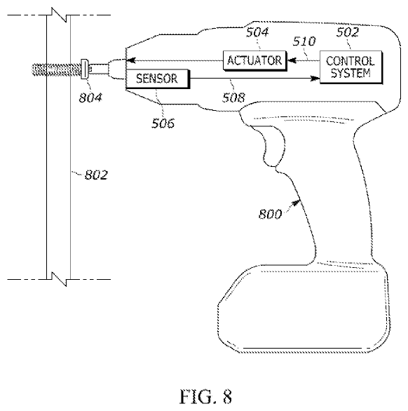

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

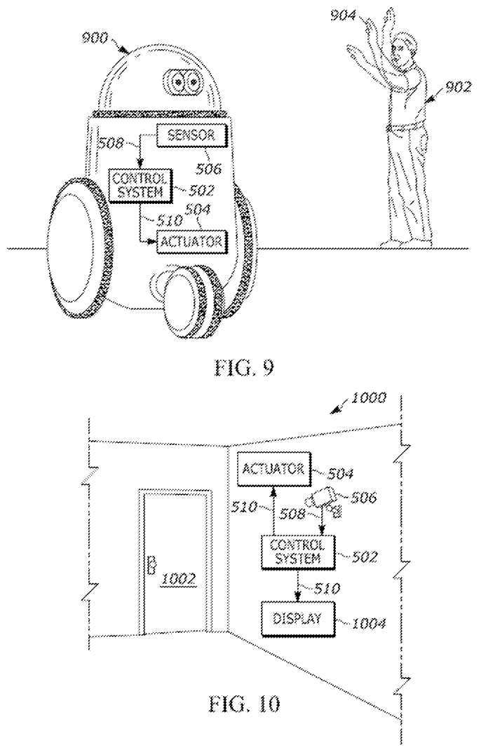

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

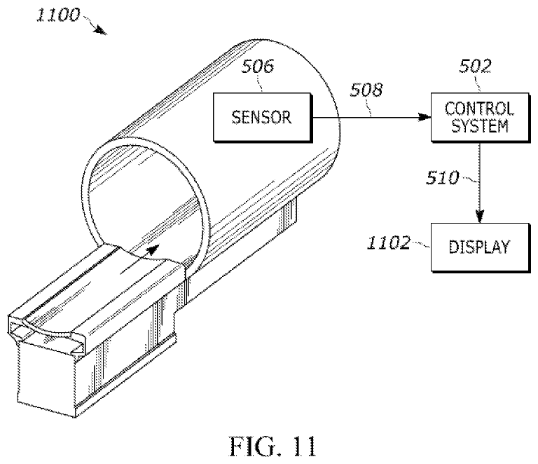

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region. The sensed image may be used internal in the hospital environment for training machine learning systems within the hospital (client), however this data is not sent to the server for training of the server's models. Instead, the hospital's adjusted weights that are adjusted based on the sensed images may be sent to the server for adjustment of the weights on the server side.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training neural networks with federated learning, the method comprising:
sending at least portions of a plurality of server-maintained machine learning models from a server to a plurality of clients, yielding a plurality of local machine learning models;
at each client, training the plurality of local machine learning models with locally-stored data that is stored locally at that respective client, wherein the training at each client includes determining a respective loss for each of the plurality of local machine learning models and updating respective weights for each of the plurality of local machine learning models;
transferring the respective updated weights from each client to the server without transferring the locally-stored data of the clients; and
at the server, training the plurality of server-maintained machine learning models with the updated weights sent from each of the clients.

2. The method of claim 1, further comprising:
selecting the plurality of server-maintained machine learning models from a pool of machine learning models.

3. The method of claim 2, wherein the plurality of server-maintained machine learning models are selected from the pool based on resource limits associated with the plurality of clients.

4. The method of claim 1, wherein the training of the plurality of local machine learning models at each client includes determining a loss based on a regularization term and one or more latent features of the local machine learning models.

5. The method of claim 4, wherein the loss determined by:
$${L}_{i} = loss ( {\sum }_{j = 1}^{{l}_{i}} {f}_{{W}_{j}} ( {D}_{i} ) , {y}_{i} ) + {λ}_{i} R ( {g}_{{W}_{1}^{( i )}} ( {D}_{i} ) , {g}_{{W}_{2}^{( i )}} ( {D}_{i} ) , … , {g}_{{W}_{{l}_{i}}^{( i )}} ( {D}_{i} ) )$$
wherein (Dᵢ, yᵢ) represents the locally-stored data at a particular one of the clients i,
wherein λ is an adjustable hyperparameter corresponding to the regularization term R, and
wherein g is the one or more latent features of the local machine learning models W₁⁽ⁱ⁾, W₂⁽ⁱ⁾, . . . , Wₗ _{ᵢ}⁽ⁱ⁾.

6. The method of claim 5, further comprising:
at the server, aggregating information received from the clients to perform the training of the plurality of server-maintained machine learning models with the updated weights.

7. The method of claim 6, wherein the aggregating includes performing:
$${min}_{{W}_{1} , {W}_{2} , … , {W}_{L}} {\sum }_{l = 1}^{L} {‖ \frac{1}{\vert {Z}_{l} \vert} {\sum }_{i ∈ {Z}_{l}} {W}_{l}^{( i )} - {W}_{l} ‖}_{F}^{2} + λ {‖ {W}_{con}^{T} {W}_{con} - I ‖}_{F}^{2}$$
wherein Z represents an index of the plurality of server-maintained machine learning models, and
wherein W_{con} denotes the concatenated weights of the plurality of server-maintained machine learning models W₁, W₂, . . . , W_{L}.

8. The method of claim 1, further comprising:
determining that a first client of the plurality of clients is disconnected or otherwise unable to receive the at least portions of the plurality of server-maintained machine learning models from the server;
connecting the first client to a neighboring client that is able to communicate with the server; and
sending the portions of the plurality of server-maintained machine learning models from the neighboring client to the first client.

9. The method of claim 8, wherein the connecting includes connecting the first client to a plurality of neighboring clients, the method further comprising:
performing an interpolation of the portions of the plurality of server-maintained machine learning models received from the plurality of neighboring clients.

10. The method of claim 9, wherein the interpolation is
$${W}_{+} = W + {\sum }_{\{ i ∈ {C}_{b} \}} {A}_{i} \cdot ( {W}_{i} - W ) ,$$
wherein W₊ is an interpolated model for models W received by the plurality of neighboring clients C_{b}, and
wherein Aᵢ is a linear combination weight for model Wᵢ.

11. A system of training neural networks with federated learning, the system comprising:
memory storing instructions; and
a plurality of processors that, when executing the instructions stored in the memory, collectively perform:
sending at least portions of a plurality of server-maintained machine learning models from a server to a plurality of clients, yielding a plurality of local machine learning models;
at each client, training the plurality of local machine learning models with locally-stored data that is stored locally at that respective client, wherein the training at each client includes determining a respective loss for each of the plurality of local machine learning models and updating respective weights for each of the plurality of local machine learning models;
transferring the respective updated weights from each client to the server without transferring the locally-stored data of the clients; and
at the server, training the plurality of server-maintained machine learning models with the updated weights sent from each of the clients.

12. The system of claim 11, wherein the instructions further cause the processors to collectively perform:
selecting the plurality of server-maintained machine learning models from a pool of machine learning models.

13. The system of claim 12, wherein the plurality of server-maintained machine learning models are selected from the pool and sent to the plurality of clients based on resource limits of the plurality of clients.

14. The system of claim 11, wherein the training of the plurality of local machine learning models at each client includes determining a loss based on a regularization term and one or more latent features of the local machine learning models.

15. The system of claim 14, wherein the instructions further cause the processors to collectively perform:
at the server, aggregating information received from the clients to perform the training of the plurality of server-maintained machine learning models with the updated weights.

16. A non-transitory computer readable storage medium tangibly embodying a computer readable program code having computer readable instructions that, when executed, cause a computing system to train neural networks with federated learning by:
sending at least portions of a plurality of server-maintained machine learning models from a server to a plurality of clients, yielding a plurality of local machine learning models;
at each client, training the plurality of local machine learning models with locally-stored data that is stored locally at that respective client, wherein the training at each client includes determining a respective loss for each of the plurality of local machine learning models and updating respective weights for each of the plurality of local machine learning models;
transferring the respective updated weights from each client to the server without transferring the locally-stored data of the clients; and
at the server, training the plurality of server-maintained machine learning models with the updated weights sent from each of the clients.

17. The computer readable storage medium of claim 16, wherein the computer readable instructions further cause the computing system to train neural networks with federated learning by:
selecting the plurality of server-maintained machine learning models from a pool of machine learning models.

18. The computer readable storage medium of claim 17, wherein the plurality of server-maintained machine learning models are selected from the pool and sent to the plurality of clients based on resource limits of the plurality of clients.

19. The computer readable storage medium of claim 16, wherein the training of the plurality of local machine learning models at each client includes determining a loss based on a regularization term and one or more latent features of the local machine learning models.

20. The computer readable storage medium of claim 19, wherein the computer readable instructions further cause the computing system to train neural networks with federated learning by:
at the server, aggregating information received from the clients to perform the training of the plurality of server-maintained machine learning models with the updated weights.
